(19) United States
(12) Patent Application Publication
(10) Pub. No.: US 2009/0234699 A1
(43) Pub. Date: Sep. 17, 2009

(54) User Interface For Scheduling Resource Assignments

(75) Inventors: Alice Pritikin Steinglass, Redmond, WA (US); Jonathan Seth Kaufthal, Seattle, WA (US); Bonny P. Lau, Bellevue, WA (US); James Coryell Hilke, Redmond, WA (US); Timothy Barrett Harahan, Issaquah, WA (US); Benjamen E. Ross, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/049,282

(22) Filed: Mar. 15, 2008

(51) Int. Cl. G06Q 10/00

(52) U.S. Cl. 705/9

(57) ABSTRACT

A project management resources scheduling user interface is provided in which resource information may be displayed in a condensed timeline for each resource over the duration of a project. Individual tasks or groups of tasks displayed in the project management resources scheduling view may be moved from one resource to another resource while respecting project constraints and dependencies. Unassigned and unscheduled tasks may be dragged onto the scheduling view and may be dropped on a given resource in a timing location required by the project. Tasks may be viewed according to a hierarchical relationship between tasks of a given project. The scheduling view may be used in combination with a Gantt chart view of project tasks for allowing a view of both task-based and resource-based scheduling.

### BACKGROUND

Electronic scheduling tools and/or applications, such as electronic project management applications, allow users to do traditional critical path method (CPM) scheduling and allow users to create various project management charts such as Gantt charts. Using such tools, users may create tasks, assign tasks to individual or teams of resources, map dependencies between tasks, assign tasks to summary tasks, etc. However, presentations of scheduling data generated by such applications, for example, in Gantt charts, are typically focused on what work items need to be done in a given project, but not on the resources (human or equipment) utilized for performing individual or groups of work tasks. While a view (display or presentation) of work tasks included in a given project may be filtered to see work assigned to a given resource, each work item is typically displayed on a separate line, and thus, it is difficult to view a condensed timeline of work tasks assigned to a given resource. Often, a project manager is interested in managing a team of multiple people, and the project manager desires to lay out tasks over time for the individual resources on the team so that the manager can see, for example, what one person is doing this week, what another person is doing next week, and so on.

It is with respect to these and other considerations that the present invention has been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments of the present invention solve the above and other problems by providing for scheduling resources via a project management resources scheduling user interface. According to one embodiment, a project management resources scheduling view (user interface) is provided in which resource (human and equipment) information may be displayed for allowing a project manager to organize and view resource scheduling for one or more tasks so that the project manager may see a condensed timeline for each resource over the time or duration required for a given project. The scheduling view may be used in combination with a Gantt chart view of project tasks for allowing a project manager/user to view a mix of task-based and resource-based scheduling.

Individual tasks or groups of tasks displayed in the project management resources scheduling view (hereinafter, “scheduling view”) may be moved (e.g., dragged and dropped) from one resource to another resource while respecting project constraints and dependencies. Unscheduled tasks may be dragged onto the scheduling view and may be dropped on a given resource in a timing location required by the project. Unassigned tasks may be displayed in the user interface and may be dragged to an active resource for inserting the unassigned tasks into a workflow timeline as desired by the project manager. Over-allocations of a given resource caused by moving a task onto a resource already allocated for the time associated with the moved task may be resolved automatically or manually.

According to one embodiment, project or work tasks may be viewed according to a hierarchical relationship between tasks of a given project. A project manager/user may view an outline of tasks included in a given project which illustrates a hierarchical relationship between tasks included in the project, and the project manager/user may “zoom in” and/or “zoom out” to view the overall project or portions of the overall project at different levels in the hierarchical outline of project or work tasks.

These and other features and advantages, which characterize the present invention, will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a simplified illustration of a project management resources scheduling user interface showing a linear representation of tasks of a given project assigned to one or more resources and showing a chart of assignment and start date changes for a given task dragged from one resource to another resource.

FIG. 2 shows an outline of tasks associated with a given project and shows a level that each task occupies in a hierarchical relationship between the tasks contained in the associated project.

FIG. 3 is a simplified illustration of a project management resources scheduling user interface showing a linear representation of tasks of a given project assigned to one or more resources and showing a different view of scheduling for the same resources viewed at a higher project task level.

FIG. 4 is a simplified illustration of a project management resources scheduling user interface showing a linear representation of tasks of a given project assigned to one or more resources and showing a scheduled, but unassigned project task.

FIG. 5 is a simplified illustration of a project management resources scheduling user interface showing a linear representation of tasks of a given project assigned to one or more resources and showing a menu of unscheduled tasks that may be dragged to a desired resource and at a desired start time in the scheduling view.

FIG. 6 illustrates the combination of a project management resource scheduling user interface (view) with an associated Gantt chart.

FIG. 7 illustrates a project management resource scheduling user interface showing a buffer task.

FIG. 8 is a simplified block diagram of an example computing operating environment in which embodiments of the present invention may be practiced.

### DETAILED DESCRIPTION

As briefly described above, embodiments of the present invention are directed to scheduling resources via a project management resources scheduling user interface. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

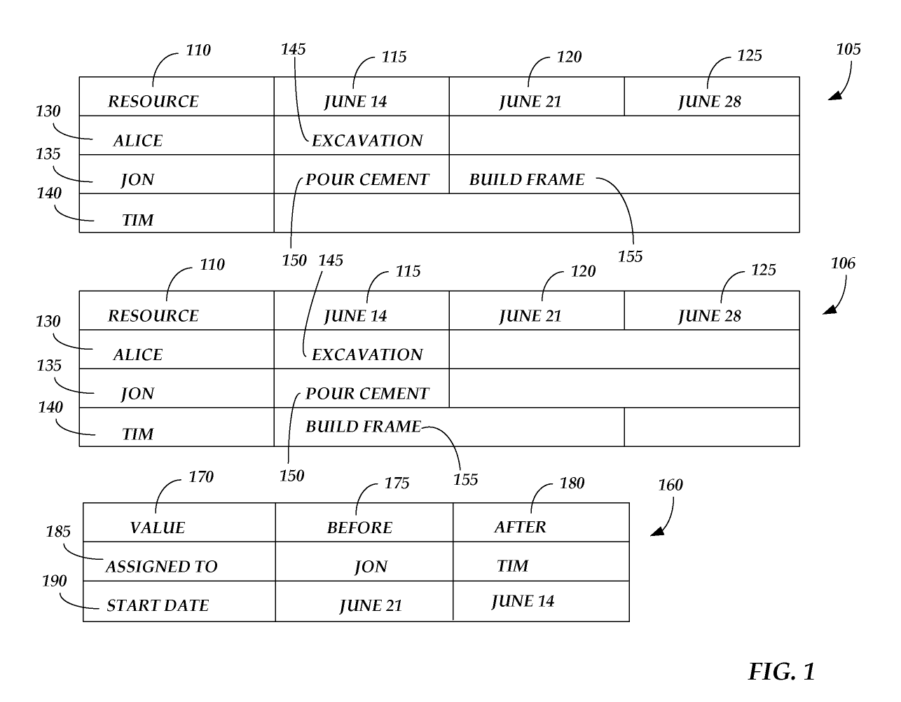

Referring now to the drawings, in which like numerals refer to like elements through the several figures, aspects of the present invention and an exemplary computing operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Embodiments of the invention may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

FIG. 1 is a simplified illustration of a project management resources scheduling user interface showing a linear representation of tasks of a given project assigned to one or more resources and showing a chart of assignment and start date changes for a given task dragged from one resource to another resource. According to one embodiment, the project management resources scheduling user interface may be provided as a functionality of an electronic project management application. An example of a suitable project management application is PROJECT manufactured by Microsoft Corporation of Redmond, Wash.

Referring still to FIG. 1, the scheduling view 105 includes a resource column 110 and a number of date columns 115, 120, 125. As should be appreciated, the information illustrated in the scheduling view 105 is for purposes of example only and is not limiting of the vast numbers of different resources and task start or stop times that may be utilized in the scheduling view 105, as described below. The scheduling view, 105 illustrated in FIG. 1, includes three example resources 130, 135, 140 in the form of three workers or professionals to which one or more tasks of a given project may be assigned. As should be appreciated, the resources 130, 135, 140 may also be in the form of equipment or other resources to which a given task or tasks of a project may be assigned. For example, the resources 130, 135, 140 may be in the form of machines utilized on a shop floor to which tasks of an overall project must be assigned.

For purposes of explanation of the scheduling view of the present invention, an example project associated with building a house, including various tasks and sub-tasks associated with building a house, will be described herein. As should be appreciated, description of the present invention in terms of a specific example project is for purposes of illustration only and is not limiting of the vast numbers of projects and associated tasks for which embodiments of the present invention may be utilized.

As illustrated in the scheduling view 105, a first human resource 130 is assigned a first task “excavation” scheduled to begin on June 14 and scheduled to run for one week. A second human resource 135 is assigned two tasks, including “pour cement” and “build frame” scheduled to begin on June 14 and June 21 respectively. The tasks of the associated project are illustrated in the scheduling view 105 in a linear representation of the tasks over a time associated with the associated project. For example, note that the tasks “pour cement” and “build frame” appear on the same line even though they represent separate tasks in the overall project.

According to one embodiment, the rectangular elements illustrated in the scheduling views 105, 106 for each assigned task may be highlighted to show the duration of the task. For example, the rectangular portion of the view 105 containing the task 145 (excavation) may be colored or shaded with a highlighting color, for example, gray, to show the duration of the task 145. Thus, the task 155 which has an example duration of two weeks would be highlighted to show that the task lasts two weeks along the timeline extending from the example June 14 through the end of the week commencing on June 28. As should be understood, any number of highlighting methods, for example colors, symbols, icons, and the like may be used to indicate the duration of a given task in the views 105, 106.

Advantageously, a project manager or user of the scheduling view 105 may manipulate the displayed schedule of tasks by moving tasks from one location in the scheduling view 105 to a different location in the scheduling view 105 to place a desired task at a different scheduling point (e.g., start time), or for assigning a desired task from one human resource 135 to a different human resource 140. According to embodiments, tasks may be moved by any suitable means for moving text of other displayed objects in a user interface, for example, by dragging and dropping, keyboard entry, voice activated text movement, etc.

For purposes of example, the scheduling view 106, illustrated immediately beneath the scheduling view 105 in FIG. 1, shows a resulting view of the tasks of the associated project after the project manager or user has dragged the “build frame” task 155 from the human resource 135 and start date of June 21 to the human resource 140 and a start date of June 14. Accordingly, the scheduling view 106 immediately shows the project manager or user a graphical representation of the utilization of his/her resources 130, 135, 140 if the project manager moves the “build frame” task 155 from its previous resource and start time to a different resource and different start time. The chart 160 illustrated immediately beneath the scheduling view 106 illustrates changes that have been made to the moved task, wherein the task assignment has been moved from Jon to Tim, and the start date for the assignment has been moved from June 21 to June 14.

According to one embodiment, moving tasks, as described above, is accomplished so that constraints, dependencies and resource schedules are respected. For example, a project manager/user may optionally use an “automatic” scheduling mechanism which will avoid resource over-allocation. According to this mechanism, tasks assigned to a given resource are adjusted so that the resource is considered as the “drop target” of the dragged task only, and so that selected tasks are from the “drop point” forward in time. All passed tasks are left undisturbed, and tasks or sets of tasks are moved based on start date/priority such that a given resource is not over-allocated with any work at any given point. At the same time, future tasks are not moved forward if such movement is not necessary to resolve an over-allocation caused by the movement of a given task.

If an “automatic” mechanism for resolving resource over-allocations is not utilized, it is possible to over-allocate a resource by moving a task to a resource during a time the resource is already allocated with a project task. If a given resource 130, 135, 140 is over-allocated, a user interface highlighting method may be used for showing the over-allocation. For example, overlapping tasks may be highlighted with an alarming highlighting color, for example, red, and the overlapping tasks may be illustrated in the view 105 in a collapsed mode. The program manager/user of the view 105 may then expand the tasks for the over-allocated resource to cause tasks assigned to the over-allocated resource to be displayed in multiple lines. Over-allocation may then be manually resolved by dragging one of the conflicting/over-allocating tasks to a different resource or to a different start time.

For example, referring to the resource scheduling view 105, if the task 150 (pour cement) is assigned to the resource 130 (Alice) wherein the resource Alice is assigned both tasks 145 and 150 to be started and completed at the same time, the rectangular space displayed in the view 105 for the subject time period may be highlighted in an alarming color, for example, red. According to an embodiment, the program manager may selectively expand the row containing tasks for the resource 130 (Alice) so that the tasks assigned to Alice are displayed on two lines which will allow the program manager to see that the over-allocation has been caused by the fact that Alice has been assigned tasks 145 and 150 to be processed during the same period. According to an embodiment, the program manager may then drag one of the over-allocated tasks from the resource 130 (Alice) to a different resource, for example, the resource 135 or 140, and thus, the program manager will quickly and efficiently resolve the over-allocation and receive an updated resource scheduling view 105 showing the new allocation of tasks to the available resources 130, 135, 140.

According to an embodiment, tasks of a given project may have a hierarchical relationship to each other as part of the overall project. For example, if the building of a house or other structure comprises an overall project, the construction of the building foundation may have a child relationship to the task of building the house, and excavating, pouring cement and curing cement may each have child relationships to the task of constructing the foundation. According to an embodiment, the project management scheduling user interface described herein may provide for choosing a level of the project hierarchy that a project manager or user is currently interacting with in the scheduling view.

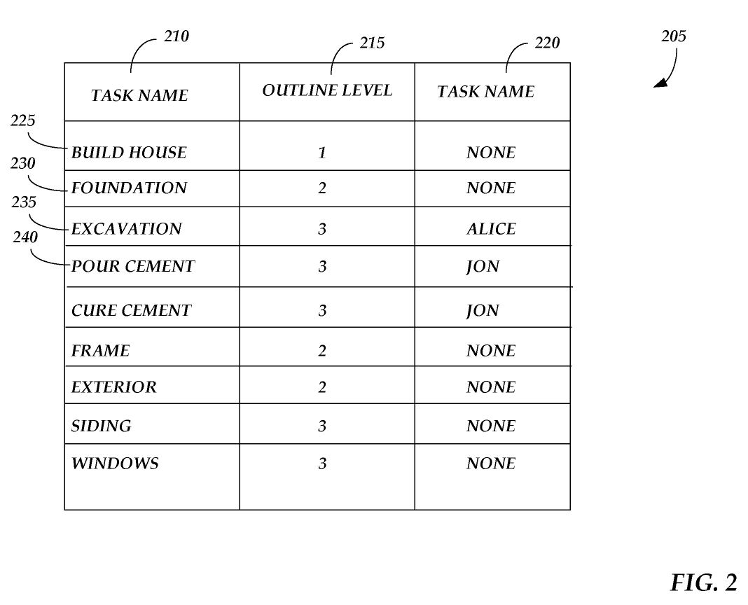

Referring to FIG. 2, a user interface 205 is illustrated and described which allows a project manager/user to select a project outline level for viewing project tasks at a selected level in a hierarchical outline of project tasks. According to one embodiment, the user may select a “Show Outline Level <in>” function where “n” is the number of levels deep in an outline structure for a given project. Alternatively, the user may use a “zoom in”/“zoom out” function for zooming to different levels of the project task hierarchy. Note that this is not a visual zoom or a time scale zoom, but rather a “data zoom” as described in the following example illustrated in Table 1.

TABLE 1

| | |
|---|---|
| 1. | Build house |

| | |
|---|---|
| 1.1 | Foundation |

| | |
|---|---|
| 1.1.1 | Excavation |
| 1.1.2 | Pour cement |
| 1.1.3 | Cure cement |

| | |
|---|---|
| 1.2 | Frame |
| 1.3 | Exterior |

| | |
|---|---|
| 1.3.1 | Siding |
| 1.3.2 | Windows |

Referring to Table 1 and FIG. 2, the user interface 205 shows each task name contained in the hierarchy of project tasks, an outline level within the hierarchy for each task and information as to which resource a given task is presently assigned. For example, the task 225 “build house” shows an outline level of “1” indicating that this task is at the highest level of the hierarchy of tasks associated with the project. The task 230 “excavation” shows an outline level of “3” which indicates that this task is a “grandchild” task to the “build house” task at outline level “1”. In addition, the user interface 205 shows that the task 230 is presently assigned to the resource Alice.

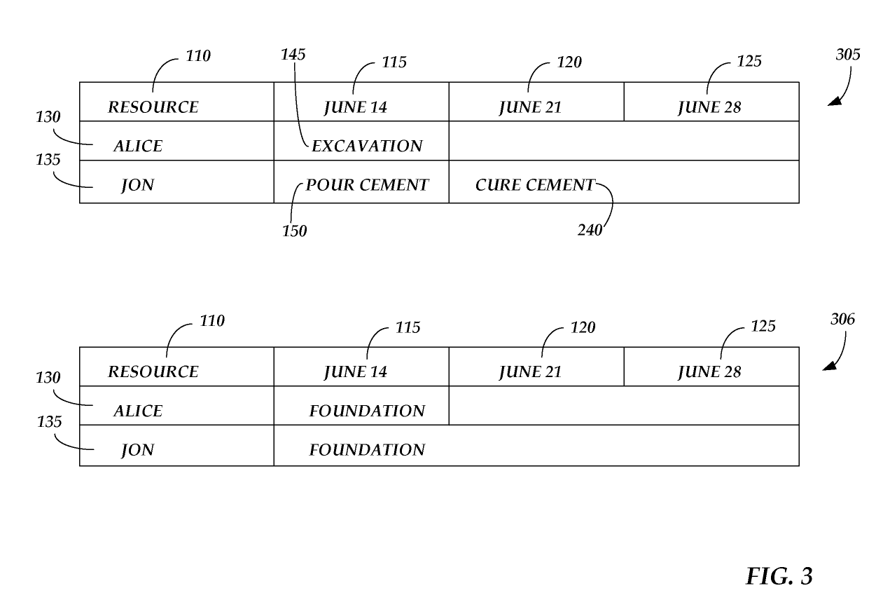

Referring to FIG. 3, the scheduling view 305 illustrates a “zooming in” to the lowest level tasks assigned to two resources “Alice” and “Jon” and shows the start dates for the associated tasks. However, if the project manager desires to “zoom out” on the subject resources to quickly ascertain higher level tasks associated with the lower level tasks displayed in the view 305, the project manager may “zoom out” to a higher outline level, for example, outline level “2”, and the project manager will receive a display of the tasks associated with the subject resources at the selected outline or hierarchical level. For example, as illustrated in the scheduling view 306 illustrated in FIG. 3 beneath the scheduling view 305, the project manager has “zoomed out” to outline level “2” which shows that the resources 130, 135 (Alice and Jon) are assigned to tasks that are part of the “foundation” level of the subject project. As should be appreciated, according to the example illustrated herein, if the project manager “zooms out” to yet a higher level, then the tasks illustrated for both resources 130, 135 (Alice and Jon) would show “build house” because the task “foundation” is a child task of the overall project “build house” according to the example hierarchical task structure/outline illustrated and described herein.

Referring still to scheduling view 306, illustrated in FIG. 3, note that the two separate tasks of “pour cement” and “cure cement” have been combined into the single task of “foundation” which appears based on the assignments of its child tasks, even though the parent task itself is not directly assigned to the resources 130, 135. If the user were to select the three week “foundation” task assigned to the resource 135 and move it out one week, the corresponding child tasks of “pour cement” and “cure cement” likewise would be moved out one week and would be illustrated as such if the project manager “zoomed in” to the outline level associated with the child tasks “pour cement” and “cure cement” as illustrated in the scheduling view 305 illustrated at the top of FIG. 3.

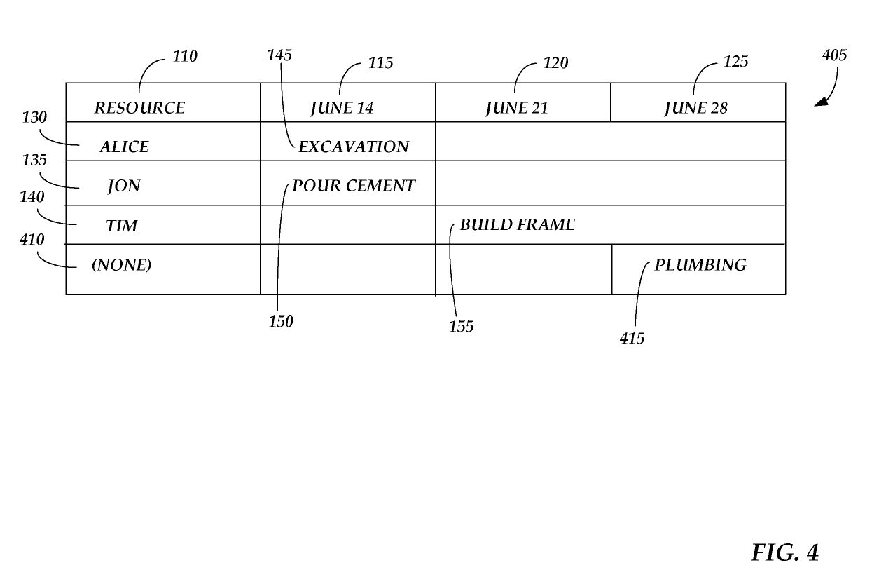

According to another embodiment, the project management scheduling view may be utilized for moving or dragging unassigned tasks to a desired resource to allow the project manager to get a quick view of how his/her resources will be allocated if a previously unassigned task is assigned to a given resource. As illustrated in FIG. 4, a task 415 (plumbing) is illustrated as having been scheduled to begin on June 28, but the plumbing task 415 is not assigned to a known resource 130, 135, 140. According to one embodiment, the unassigned task 415 may occupy a position in the scheduling view 405 in a row associated with an unknown resource 410 before the task is assigned to a known resource 130, 135, 140. If the project manager desires to move the unassigned task 415 to a known resource, he/she may drag the unassigned task 415 from its present location to one of the known resources 130, 135, 140, and the task will be inserted into the linear representation of tasks associated with the resource to which the task is dropped to allow the project manager to better allocate tasks to his/her resources.

For example, if the plumbing task 415 must begin on June 28 due to dependencies or constraints associated with other tasks, the project manager may drag the plumbing task to the resource 140 (Tim), and the plumbing task may be inserted out one week past the build frame task 155 if the plumbing task will place the resource Tim in an over-allocation mode. On the other hand, if the project manager desires to have the plumbing task performed by the resource 135 (Jon), the plumbing task may be dragged to the row containing the resource 135, and the plumbing resource may be inserted at the June 28 start date for which it is presently scheduled. Alternatively, if the plumbing task may begin as early as June 21, while still respecting any constraints or dependencies associated with the plumbing task in relation to other tasks of the project, the project manager may drag the plumbing task to a start date of June 21 to be performed by one of the two resources 130, 135. In short, the project manager may utilize the scheduling view 405 for quickly dragging unassigned tasks 415 to particular resources so that the project manager may quickly and efficiently manage his/her resources through a visualization of the workflow resulting in an assignment of the previously unassigned task.

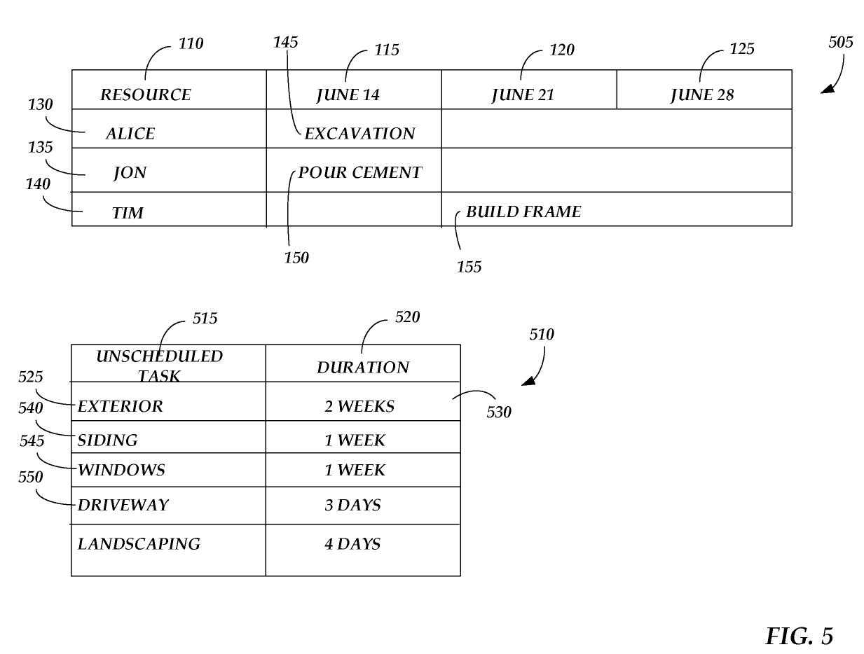

Referring now to FIG. 5, unscheduled tasks may be moved or dragged to the project management scheduling view 505 for scheduling and assigning previously unscheduled and/or unassigned tasks to one or more project resources 130, 135, 140. According to this embodiment, a user interface 510 may be launched for displaying to the project manager one or more unscheduled and/or unassigned tasks 515 that must be performed as part of the overall project. According to an embodiment, the user interface 510 may be a menu, for example, a drop down menu, a fly out menu, a dialog box, a static menu, and the like, that is launched from an associated project management application 100 to show the project manager those tasks that have not been assigned and/or scheduled, and thus, that do not presently show on the scheduling view 505, as illustrated in FIG. 5.

As should be appreciated, the menu 510 may include only those tasks that have not been scheduled, or the menu may include tasks that have not been scheduled or that have not been assigned. Alternatively, tasks may be scheduled (but not yet assigned to a resource) and may appear on the scheduling view 405, as illustrated and described above with respect to FIG. 4, or the scheduling view 505 may display only tasks that have been scheduled and assigned, and the menu 510 may be utilized for moving unassigned or unscheduled tasks to the scheduling view 505.

According to an embodiment, the project manager may move tasks from the menu 510 to the scheduling view 505 by moving a task from the menu 510 to a desired scheduling view 505, as illustrated in FIG. 5. For example, if the project manager desires to move the “Exterior” task 525 to the scheduling view 505, and the project manager desires to assign the task 525 to the resource 140, then the project manager may drag the task 525 from the menu 510 to the resource 140, and the task 525 will be placed in the linear representation of tasks assigned to the resource 140 in a manner that respects any constraints or dependencies associated with the task 525 in relation to other tasks presently displayed in the scheduling view 505. For example, if a dependency requires that the “Exterior” task 525 may only commence after the “Build frame” task 155, then the task 525 will be displayed for the resource 140 after completion of the “Build frame” task 155. On the other hand, if the “Landscaping” task may begin prior to completion of the “Build frame” task 155, the project manager may drag the “Landscaping” task to a resource 130, 135 and show the “Landscaping” task commencing prior to completion of the “Build frame” task for the resource 130, 135 to which the landscaping task is assigned.

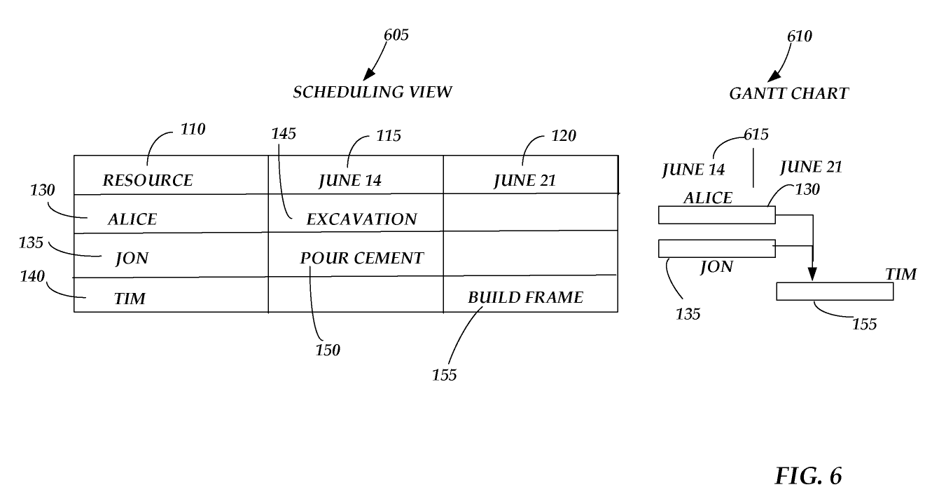

Referring now to FIG. 6, according to an embodiment, the project management resource scheduling view 605 may be utilized in combination with a classic Gantt chart view of work tasks for allowing a project manager to view a mix of task-based and resource-based scheduling for better and more efficiently managing his/her project resources. As is known to those skilled in the art, a Gantt chart is typically illustrated as a bar chart that shows the elements of a project schedule. Gantt charts typically illustrate start and finish dates of beginning and ending tasks and a summary of tasks occurring between the beginning and ending tasks for a given project. Accordingly, while the Gantt chart is a task-based view showing the workflow of a project based on tasks required for the project, including constraints and dependencies for tasks in relation to other tasks of a given project, the project management resource scheduling view of the present invention is a resource-based view which illustrates a linear representation of tasks assigned to one or more resources over a period of time associated with a subject project.

The resource-based scheduling view 605 of the present invention may be provided in combination with a task-based view 610 provided in the form of a Gantt chart to allow the project manager an efficient visualization of the utilization of his/her resources in combination with a task-based visualization provided by a Gantt chart. Referring to FIG. 6, a scheduling view 605 is illustrated showing three tasks assigned to resources Alice, Jon, and Tim to allow the project manager to visualize the tasks in a resource-based manner. A Gantt chart 610 is presented immediately adjacent to the scheduling view 605 showing the tasks 145, 150, 155 in a task-based Gantt chart for allowing the project manager to visualize the tasks in a task-based manner. According to an embodiment, the scheduling view 605 and the Gantt chart 610 may be functionally associated with each other via the project management application 100. Thus, if the project manager moves a task in the scheduling view 605 from one resource to another resource or from one start date to a different start date, as described above, the change will be illustrated in the scheduling view 605, and correspondingly, the change will be illustrated in the task-based Gantt chart 610 for allowing the project manager a quick and efficient visualization of the effects of the changes made to the project schedule and assignments.

According to an embodiment, a buffering feature may be provided by an electronic project management application, and the buffering feature may be graphically presented in a scheduling view as described below. Referring again to FIG. 1, consider an example where Jon is not only a person doing the “build frame” task, but where Jon is also responsible for managing a team of employees who are involved in the “build frame” task. Consider also that the total duration for the task is 120 hours spread across three 40 hour work weeks for Jon and two employees on the team of employees assigned to the “build frame” task. If Jon has “management duties” that must be done continuously and in parallel with the framing tasks, his management duties will naturally cut into his individual contribution as a part of the “build frame” team.

Continuing with this example, according to an embodiment, a “buffer” task may be assigned to Jon, for example, a buffer task called “management duties.” This buffer task is not sized in hours, but rather has a duration and a percentage effort associated with the required buffer. For example, Jon may have a two week task called “management duties” that will take up 50% of his time. The net result is that, unlike other tasks, the “management duties” task can be scheduled and executed in parallel to the other tasks. Further, in the scheduling view, described herein, as a user moves (e.g., drags) a task from being done on its own to being done in combination with a buffer task (i.e., overlapping tasks), the user may be provided a duration of the task increase. In the example above, 20% of Jon's 40 hour week (8 hours) is assumed to be accounted for by the buffer task. Thus, 40 hours of framing work will actually take Jon longer than 40 hours. The “build frame” task will take Jon 50 hours because he is working on the framing work less than full time while he is executing the buffer task (e.g., management duties).

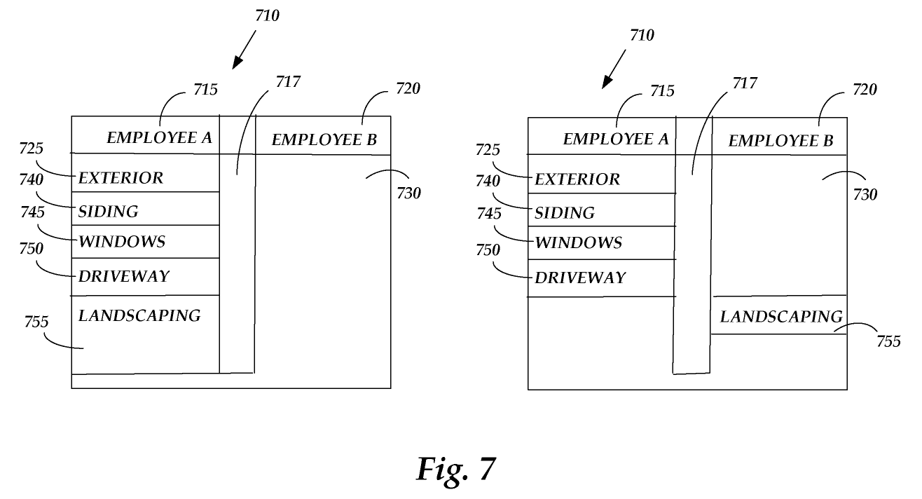

Referring now to FIG. 7, the schedules of two employees are illustrated in vertical side-by-side orientation. On the left side, the schedules of the two employees are illustrated before a task (e.g., “Landscaping”) is moved from Employee A to Employee B. As illustrated in FIG. 7, Employee A has a relatively full schedule, and Employee A has a “buffer” 717 that indicates that Employee A will be spending time managing the scheduled activities. The schedule for Employee B shows no scheduled work items. On the right side of FIG. 7, the “Landscaping” task 755 has been moved from Employee A to Employee B. Employee B does not have a “buffer” associated with any of the tasks, and thus, as illustrated in FIG. 7, the duration for the moved task (e.g., “Landscaping”) has reduced because buffered time is no longer built into the task for the new Employee B. This is because Employee B is able to apply his/her full attention to that task and does not have any buffer tasks.

According to an embodiment, multiple buffer tasks may be stacked side-by-side and they will accumulate impact on corresponding regions of the schedule. For example, if a 25% buffer and a 50% buffer are included during two weeks of a given schedule, tasks executing during that time would be expected to proceed at 25% speed. Schedule time may be logged against a buffer task like any other task, but according an embodiment, the percentage time is the important scheduling factor. For example, consider a 50% buffer that lasts for 2 weeks. One way of describing the associated task it to consider the it as a 40-hour task that will last 2 weeks. In that scenario, one would expect that logging 40 hours against the task for the first week would indicate zero (0) hours remaining for the second week. However, according to the buffering feature, even though the 40 hours were spent on the task in the first week, there is an associated 50% buffer task, and therefore, 20 additional hours are expected on the task in the second week, and the duration of other tasks will be pushed out assuming this to be the case.

### Operating Environment

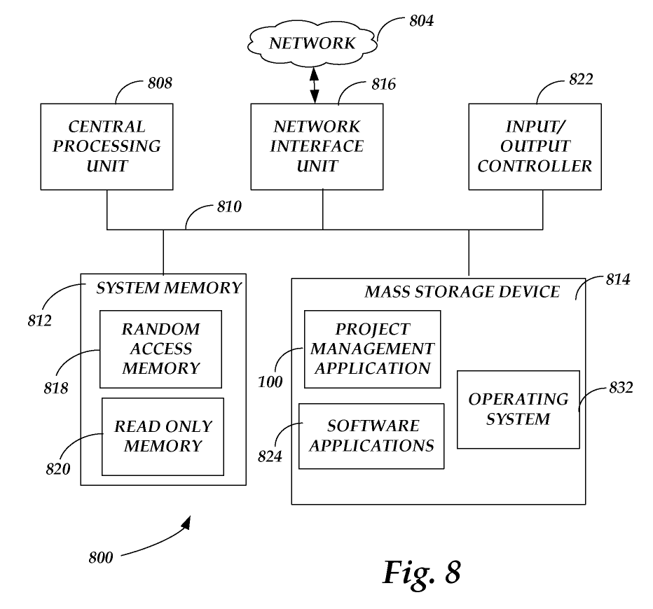

Referring now to FIG. 8, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 8, an illustrative operating environment for embodiments of the invention will be described. As shown in FIG. 8, computer 800 comprises a general purpose desktop, laptop, handheld, mobile or other type of computer (computing device) capable of executing one or more application programs. The computer 800 includes at least one central processing unit 808 (“CPU”), a system memory 812, including a random access memory 818 (“RAM”) and a read-only memory (“ROM”) 820, and a system bus 810 that couples the memory to the CPU 808. A basic input/output system containing the basic routines that help to transfer information between elements within the computer, such as during startup, is stored in the ROM 820. The computer 802 further includes a mass storage device 814 for storing an operating system 832, application programs, and other program modules.

The mass storage device 814 is connected to the CPU 808 through a mass storage controller (not shown) connected to the bus 810. The mass storage device 814 and its associated computer-readable media provide non-volatile storage for the computer 800. Although the description of computer-readable media contained herein refers to a mass storage device, such as a hard disk or CD-ROM drive, it should be appreciated by those skilled in the art that computer-readable media can be any available media that can be accessed or utilized by the computer 800.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 800.

According to various embodiments of the invention, the computer 800 may operate in a networked environment using logical connections to remote computers through a network 804, such as a local network, the Internet, etc. for example. The computer 802 may connect to the network 804 through a network interface unit 816 connected to the bus 810. It should be appreciated that the network interface unit 816 may also be utilized to connect to other types of networks and remote computing systems. The computer 800 may also include an input/output controller 822 for receiving and processing input from a number of other devices, including a keyboard, mouse, etc. (not shown). Similarly, an input/output controller 822 may provide output to a display screen, a printer, or other type of output device.

As mentioned briefly above, a number of program modules and data files may be stored in the mass storage device 814 and RAM 818 of the computer 800, including an operating system 832 suitable for controlling the operation of a networked personal computer, such as the WINDOWS operating systems from MICROSOFT CORPORATION of Redmond, Wash. The mass storage device 814 and RAM 818 may also store one or more program modules. In particular, the mass storage device 814 and the RAM 818 may store application programs, such as a software application 824, for example, a word processing application, a spreadsheet application, a slide presentation application, a database application, etc.

According to embodiments of the present invention, the project management resources scheduling user interface, described herein, may be provided as a functionality of an electronic project management application 100. An example of a suitable project management application 100 is PROJECT manufactured by Microsoft Corporation of Redmond, Wash.

It should be appreciated that various embodiments of the present invention may be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various embodiments, those of ordinary skill in the art will understand that many modifications may be made thereto within the scope of the claims that follow. Accordingly, it is not intended that the scope of the invention in any way be limited by the above description, but instead be determined entirely by reference to the claims that follow.

We claim:

1. A method of displaying tasks of a work project wherein the tasks are displayed in linear representation over time for each resource to which one or more of the tasks are assigned, comprising:
providing an electronic resource scheduling view for displaying one or more tasks of a work project;
providing a row in the resource scheduling view for each resource to which one or more tasks may be assigned;
receiving into the resource scheduling view a selected task assigned to a selected resource; and
if the selected task received into the resource scheduling view causes an over-allocation of the selected resource at a desired start time, moving one or more other tasks presently positioned in the row that may be performed after the received selected task to future start times corresponding to the one or more other tasks to prevent the over-allocation.

2. The method of claim 1, wherein receiving into the resource scheduling view a selected task assigned to a selected resource includes receiving an insert of the selected task into a row in the resource scheduling view associated with the selected resource.

3. The method of claim 2, wherein receiving into the resource scheduling view a selected task assigned to a selected resource includes receiving the insert of the selected task at a position along the row in the resource scheduling view associated with the selected resource corresponding to a desired start time for the selected task.

4. The method of claim 1, wherein receiving the insert of the selected task includes receiving the task from a menu of unscheduled tasks into the resource scheduling view.

5. The method of claim 1, wherein if the selected task received into the resource scheduling view causes an over-allocation of the selected resource at the desired start time, providing a graphical indication of the over-allocation of the selected resource at the desired start time.

6. The method of claim 5, further comprising:
receiving a selection of the graphical indication;
adding an additional row beneath the row in the resource scheduling view associated with the selected resource; and
displaying the task causing the over-allocation in the additional row for providing a graphical representation of the over-allocation of the selected resource.

7. The method of claim 6, further comprising receiving a movement of the task causing the over-allocation to a different resource for resolving the over-allocation.

8. The method of claim 1, further comprising receiving a movement of a task presently assigned to a first resource and presently positioned in a row in the resource scheduling view associated with the first resource to a row in the resource scheduling view associated with a second resource for reassigning the task presently assigned to the first resource to the second resource.

9. The method of claim 8, further comprising displaying the resource scheduling view with the task presently assigned to the first resource now assigned to the second resource.

10. The method of claim 1, further comprising positioning an unassigned task in a row in the resource scheduling view that is not associated with a resource wherein the unassigned task is positioned based on a required start time.

11. The method of claim 10, further comprising receiving a movement of the unassigned task to a row in the resource scheduling view associated with a desired resource for assigning the unassigned task to the desired resource.

12. The method of claim 1,
wherein a plurality of tasks contained in the resource scheduling view are hierarchically related to each other;
wherein at least one task is at a first level of an associated project; and
wherein other tasks are at one or more lower levels of the associated project.

13. The method of claim 12, further comprising providing a display of the scheduling view showing only those tasks occupying a selected hierarchical level relative to other tasks of the associated project.

14. The method of claim 13, further comprising:
receiving a selection of a different hierarchical level for viewing tasks occupying the different hierarchical level; and
providing a display of the scheduling view showing only those tasks occupying the different hierarchical level.

15. A method of displaying tasks of a work project, comprising:
providing an electronic resource scheduling view for displaying one or more tasks of a work project;
providing a row in the resource scheduling view for each resource to which one or more tasks may be assigned;
receiving into the resource scheduling view one or more selected tasks assigned to a first resource;
displaying the one or more selected tasks in linear representation over time in a row in the resource scheduling view associated with the first resource;
allowing movement of a given task from the row in the resource scheduling view associated with the first resource to second row in the resource scheduling view associated with a second resource for assigning the given task to the second resource; and
displaying the resource scheduling view showing the given task positioned in the second row associated with the second resource.

16. The method of claim 15, wherein if a movement of the given task to the second row in the resource scheduling view associated with a second resource for assigning the given task to the second resource causes an over-allocation of the second resource at a start time associated with the given task, moving one or more other tasks presently positioned in the second row that may be performed after the given task to future start times corresponding to the one or more other tasks to resolve the over-allocation.

17. The method of claim 15, wherein if a movement of the given task to the second row in the resource scheduling view associated with a second resource for assigning the given task to the second resource causes an over-allocation of the second resource at a start time associated with the given task, providing a graphical indication in the resource scheduling view of the over-allocation of the second resource, and allowing manual movement of the given task to a different resource to resolve the over-allocation.

18. The method of claim 17, wherein allowing manual movement of the given task includes:
receiving a selection of the graphical indication;
adding an additional row beneath the row in the resource scheduling view associated with the second resource; and
displaying the task causing the over-allocation in the additional row for providing a graphical representation of the over-allocation of the second resource.

19. The method of claim 15, further comprising, assigning a buffer task to a given resource in the resource scheduling view, the buffer task being assigned a duration and a percentage effort, wherein the buffer task is scheduled in parallel to one or more other tasks so that a duration of the one or more other tasks accounts for the duration and percentage effort assigned to the buffer task.

20. A computer readable medium containing computer executable instructions which when executed by a computer perform a method of displaying tasks of a work project, comprising:
providing an electronic resource scheduling view for displaying one or more tasks of a work project;
providing a row in the resource scheduling view for each resource to which one or more tasks may be assigned;
receiving into the resource scheduling view one or more selected tasks assigned to a first resource;
displaying the one or more selected tasks in linear representation over time in a row in the resource scheduling view associated with the first resource; and
allowing movement of an unassigned or unscheduled task into the resource scheduling view and into a row in the resource scheduling view associated with a desired resource for assigning the unassigned or unscheduled task to the desired resource.
